(19) United States
(12) Patent Application Publication
(10) Pub. No.: US 2003/0097637 A1
(43) Pub. Date: May 22, 2003

(54) Schema generation apparatus, data processor, and program for processing in the same data processor

(75) Inventors: Akihiko Tozawa, Tokyo-to (JP); Makoto Murata, Kawasaki-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/219,620

(22) Filed: Aug. 15, 2002

(30) Foreign Application Priority Data
Sep. 4, 2001 (JP) 2001-267212

(51) Int. Cl. G06F 15/00

(52) U.S. Cl. 715/513

(57) ABSTRACT

Ensures that an XSLT stylesheet used for desired conversion processing is consistent with an input schema and an output schema. In an example embodiment, there are provided an XSLT stylesheet input unit for inputting an XSLT stylesheet, an output schema input unit for inputting an output schema, and an inference execution unit which generates a production rule for expressing a document schema on the basis of the XSLT stylesheet and the output schema input, the production rule being derived by using a predetermined inference rule. The document schema expressed by the production rule generated is compared with the input schema to determine consistency of the XSLT stylesheet with the input schema and the output schema.

### FIELD OF THE INVENTION

The present invention relates to a method for ensuring consistency of an XSLT stylesheet with document schemas in input and output documents in conversion of an XML document using the XSLT stylesheet.

### BACKGROUND ART

In the Extensible Markup Language (XML), it is possible to describe, through description of a document schema, in what document structure an XML document is acceptable. For example, a Document Type Definition (DTD) is a typical schema language for describing a document schema. In some cases of data exchange using XML documents, structural conversion of an XML document in a certain form (document structure) into another XML document in a different form is required according to an application using the XML document or a communication environment.

XSL Transformations (XSLT) are known as a language for forming from an XML document in one form another XML document in a different form by structural conversion. XSLT is formulated by the World Wide Web Consortium (W3C) and many instances of implementation of XSLT are known. An XML document in any form may be input to an XSLT stylesheet made by XSLT to form another XML document in a different form structurally converted.

Ordinarily, an XSLT stylesheet is written by supposing to what document schema an input document conforms (a document schema in this case is referred to as “input schema” hereinafter) and to what document schema an output document must conform (a document schema in this case is referred to as “output schema” hereinafter). In some case, e.g., a case where a search in a large document such as a data base is written by XSLT, or the case of an XSLT style sheet for converting an XML document into an HTML document or an XHTML document, an input schema is previously known or an output schema is explicitly determined.

XSLT, however, uses no such input and output schemas. That is, with an XSLT stylesheet, XML documents are converted irrespective of document schemas, and it is not ensured that a document output from the XSLT sheet conforms to an output schema. To ensure conformity of output documents with an output schema in such a case, it is necessary to actually collate each output document with the output schema. For example, if there are a hundred input documents, there is a need to collate each of a hundred output documents with an output schema. Moreover, in this case, it is not ensured that an output document obtained by processing the 101th input document conforms to the desired output schema and it is also necessary to separately collate this output document with the output schema.

As described above, an XSLT stylesheet structurally converts XML documents irrespective of document schemas. This does not ensure that an XSLT stylesheet is consistent with an input schema and with an output schema. To determine whether each of a number of output documents conforms to an output schema, an individual check of each output document is required.

In a case where an XSLT stylesheet containing an error is used, there is a possibility of failure to obtain an XML document which conforms to an expected output schema even from an input XML document which conforms to an expected input schema. Conventionally, it is necessary for a programmer to actually repeat a particular operation, e.g., a test of conversion of XML documents by him/herself in order to detect such an error in an XSLT stylesheet.

For solution of this problem, propositions were made to design and use a language capable of both structural conversion of XML documents (referred to as document conversion, hereinafter) and conversion of a schema in XML documents (schema inference) instead of XSLT. XDuce and Type Checking for XML transformers are examples of such a conversion language.

XDuce is a language for schema inference in the forward direction. That is, an input schema and a conversion program are given, an internal intermediate schema is made, and a determination is made as to whether an output schema designated by a user and the intermediate schema are consistent with each other. Implementations of XDuce have been made public. On the other hand, Type Checking for XML transformers was proposed as a method for schema inference in the reverse direction, i.e., a method in which an output schema and a conversion program are given and an input schema is inferred from the output schema.

It is possible to ensure that if a document which conforms to an input schema is converted by using conversion language such as XDuce, with the result of conversion conforming to an output schema. Since XDuce or the like is a special-purpose conversion language, it is not expected to be widely used like XSLT formulated by the W3C. Moreover, schema inference by XDuce ensures only soundness.

The proposal of Type Checking for XML transformers enables sound and complete schema inference. However, it showed no realizable method and showed only that such schema inference is theoretically possible.

The denotations of “sound” and “complete” will now be described. Schema inference in the forward direction used in XDuce is defined as:

1. “sound” if any of all documents belonging to a given input schema is unfailingly converted into an output document belonging to an inferred schema, and

2. “complete” if any input document capable of being converted into an output document of the inferred schema belongs to the input schema without exception.

On the other hand, schema inference in the reverse direction is defined as

1. “sound” if any of all documents belonging to an inferred schema is converted into an output document belonging to a given output schema, and

2. “complete” if a schema is inferred such as to include all input documents capable of being converted into output documents belonging to the given output schema.

The distinction between “sound” and “complete” states of schema inference is recognized from soundness and completeness about “schema check (schema verification)” realizable by using the schema inference. In “schema check”, static analysis of a given program is performed to obtain a result YES or NO of determination as to whether the program is correct (whether the program functions always correctly so as not to destruct a schema). In the case where schema inference in the reverse direction is used, if an inferred schema includes an input schema of the given program, the result is YES. If the inferred schema does not include the input schema of the given program, the result is NO. On the other hand, in the case where schema inference in the forward direction is used, if a given output schema includes an inferred schema, the result is YES. If the given output schema does not include the inferred schema, the result is NO. In either case, soundness or completeness of “schema check” results from soundness or completeness in the schema inference. However, soundness and completeness about “schema check” are as described below.

1. “Sound” is to be referred to if any program is correct when “schema check” answers “YES”.

2. “Complete” is to be referred to if “schema check” answers “YES” with respect to all correct programs.

Ordinarily, schema check of a programming language with schemas needs to be sound. It is desirable that it is complete. In ordinary cases, however, it cannot be complete.

As described above, the conventional XSLT stylesheet does not ensure its consistency with an input schema and with an output schema and, therefore, cannot mechanically ensure conformity of an output document with an output schema. Even if a special language such as XDuce is used instead of XSLT, the problem still remains that such a language is unsatisfactory in practical performance and is difficult to widely use because of its specialty.

There is a demand for a means for ensuring consistency of an XSLT stylesheet with an input schema and with an output schema to improve the reliability with which XML documents are converted by using XSLT stylesheet. If such a means is realized, it will be widely used easily in combination with XSLT.

### SUMMARY OF THE INVENTION

An aspect of the present invention is to ensure consistency of an XSLT stylesheet used in desired conversion processing with an input schema and with an output schema without using a special language such as XDuce.

Another aspect of the present invention is to ensure that the XSLT stylesheet operates correctly.

Still another aspect of the present invention is to ensure consistency of an XSLT stylesheet with an input schema and with an output schema, and to thereby enable ascertainment of the structural range of an XML document capable of being converted into an XML document having a desired output schema in a case where no input schema exists.

### BRIEF DESCRIPTION OF THE DRAWINGS

FIG. 1 is a diagram schematically showing an example of a hardware configuration of a computer apparatus suitable for realizing a schema generation and verification system which represents an embodiment of the present invention;

FIG. 2 is a diagram showing a configuration of the schema generation and verification system of an embodiment of the invention realized by the computer apparatus shown in FIG. 1;

FIG. 3 is a diagram for explaining an inference operation of an inference execution unit in an embodiment of the invention;

FIG. 4 is a flowchart for explaining a procedure of inference performed by the inference execution unit in an embodiment of the invention;

FIG. 5 is a diagram illustrating an inference rule used in an embodiment of the invention when XSLT expression is e,

FIG. 6 is a diagram illustrating an inference rule used in an embodiment of the invention when XSLT expression is element(s){e};

FIG. 7 is a diagram illustrating an inference rule used in an embodiment of the invention when XSLT expression is copy{e};

FIG. 8 is a diagram illustrating an inference rule used in an embodiment of the invention when XSLT expression is if(s){e};

FIG. 9 is a diagram illustrating an inference rule used in an embodiment of the invention when XSLT expression is foreach{e};

FIG. 10 is a diagram for explaining a binary tree grammar used in an embodiment of the invention;

FIG. 11 is a diagram showing an example of an XSLT script to be processed in an embodiment of the invention;

FIG. 12 is a diagram showing an example of an output grammar to be processed in an embodiment of the invention; and

FIG. 13 is a diagram showing an example of a configuration of a debugger in which an embodiment of the invention is implemented.

DESCRIPTION OF SYMBOLS

| | |
|---|---|
| 10 | XSLT stylesheet input unit |
| 20 | output scheme input unit |
| 30 | inference execution unit |
| 40 | input grammar output unit |
| 101 | central processing unit (CPU) |
| 102 | mother board (M/B) chip set |
| 103 | main memory |
| 104 | video card |
| 105 | hard disk |
| 106 | network interface |
| 107 | floppy^{\dot{o}} disk drive |
| 108 | keyboard |
| 109 | I/O port |
| 110 | bridge circuit |
| 1310 | data input unit |
| 1320 | data storage unit |
| 1330 | schema generation unit |
| 1340 | consistency determination unit |
| 1350 | output control unit |

### DESCRIPTION OF THE INVENTION

To attain the above-described aspects, the present invention provides a schema generation apparatus having XSLT stylesheet input means for inputting an XSLT stylesheet, schema input means for inputting a document schema to which predetermined XML data should conform, and inference execution means for generating a production rule for expressing another document schema on the basis of the XSLT stylesheet input by the XSLT stylesheet input means and the document schema input by the schema input means, the production rule being derived by using a predetermined inference rule.

More specifically, the schema input means substitutes a predetermined set of production rules for the input document schema, and the inference execution means generates the production rule for expressing the another document schema on the basis of the set of production rules substituted. Advantageously, the production rule generated by the inference execution means is expressed in a regular tree language.

Further, in some embodiments, the above-described schema generation apparatus includes conversion means for converting the production rule generated by the inference execution means into a concrete document schema in a predetermined schema language.

The present invention also provides a data generation apparatus having input means for inputting an XSLT stylesheet, an input schema which is a document schema to which XML data before conversion by the XSLT stylesheet should conform, and an output schema which is a document schema to which the XML data after conversion by the XSLT stylesheet should conform, storage means for storing the XSLT stylesheet input, the input schema, and the output schema, schema generation means for generating a predetermined document schema on the basis of one of the input schema and the output schema read out from the storage means and the XSLT stylesheet read out from the storage means, and determination means for determining consistency of the XSLT stylesheet with the input schema and the output schema by comparing the document schema generated by the schema generation means with the other of the input schema and the output schema read out from the storage means.

In more particular embodiments, the schema generation means generates the predetermined document schema by inference in the reverse direction on the basis of the output schema and the XSLT stylesheet, and the determination means compares the generated predetermined document schema with the input schema to thereby determine consistency of the XSLT stylesheet with the input schema and the output schema.

Also, the determination means determines that the XSLT stylesheet, the input schema and the output schema have consistency if the generated document schema is equal to the input schema with which it is compared, or if the document schema is included by the input schema.

The present invention can also be realized as a data processor having the above-described input means and storage means, and determination means for reading out the XSLT stylesheet, the input schema, and the output schema from the storage means, and for making a determination as to whether XML data obtained by converting the XML data conforming to the input schema by the XSLT stylesheet conforms to the output schema.

The present invention also provides a data processing method using a computer, characterized by including a step of storing, in element generation instruction storage means, element generation instructions contained in an XSLT stylesheet; a step of storing, in production rule storage means, a production rule for expressing a document schema to which predetermined XML data should conform; a step of reading out the element generation instructions from the element generation instruction storage means, and reading out the production rule from the production rule storage means; and generating a production rule for expressing another document schema on the basis of the element generation instructions and the production rule read out, the production rule being derived by using a predetermined inference rule.

Often, the step of generating the production rule includes a step of generating, by performing inference in the reverse direction, the production rule for the document schema to which the XML data input to the XSLT stylesheet should conform. This is performed on the basis of the element generation instructions and the production rule for the document schema, to which XML data generated as a result of conversion by the XSLT stylesheet, should conform.

In some embodiments, the step of generating the production rule includes a step of generating the production rule expressed in a regular tree language.

In further example embodiments the above-described data processing method includes a step of determining correctness of the predetermined XML data, or the XSLT stylesheet, by comparing the document schema expressed by the production rule generated in the step of generating the production rule with the document schema relating to the predetermined XML data.

The present invention can also be realized as a program for realizing the above-described schema generation apparatus or data processor by controlling a computer, or for executing the above-described data processing method. This program may be distributed by being stored on a storage medium such as a magnetic disk, an optical disc, or a semiconductor memory, or may be distributed through a network. In this manner, the program can be provided to users.

A detailed embodiment of the present invention will be described below in detail with respect to an embodiment thereof with reference to the accompanying drawings following an outline of the invention. According to the present invention, an XSLT stylesheet is construed as a group of element generation instructions. Also, a schema (input schema or output schema) of an XML document is expressed as a group of production rules. An inference rule group for schema inference is repeatedly used to infer and produce production rules from the element generation instructions of an XSLT stylesheet and the production rules in a schema (input schema or output schema) of an XML document. For example, an input schema of an XML document (input document) before conversion can be inferred on the basis of an XSLT stylesheet and an output schema of an XML document (output document) after conversion. In this manner, an XSLT stylesheet, an output schema and an input schema can be obtained with consistency of the XSLT stylesheet with the schemas ensured.

More specifically, it is ensured that if an XML document which conforms to an input schema obtained by this inference is input to an XSLT stylesheet used in this inference, an output document produced conforms to an output schema used in this inference. Conversely, it is ensured that, to obtain, by conversion with an XSLT stylesheet used in this inference, an output document which conforms to an output schema used in this inference, an XML document which conforms to an input schema obtained by this inference may be provided as an input document. Further, it is ensured that if an output document which conforms to an output schema used in this inference is obtained by inputting to an XSLT stylesheet an XML document which conforms to an input schema obtained by this inference, the XSLT stylesheet is operating correctly.

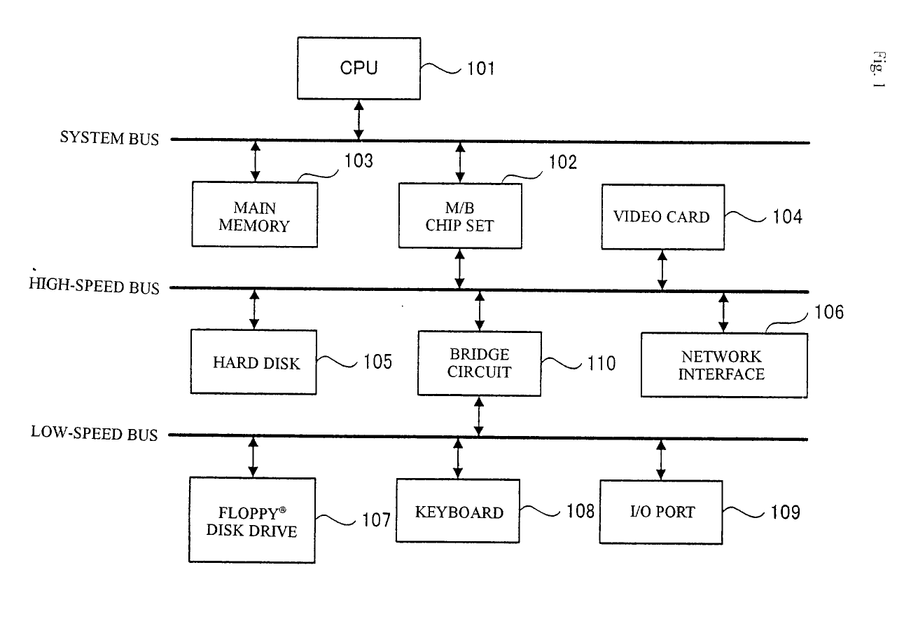

FIG. 1 is a diagram schematically showing an example of a hardware configuration of a computer apparatus suitable for realizing a schema generation and verification system which represents an embodiment of the present invention. The computer apparatus shown in FIG. 1 has a central processing unit (CPU) 101, a mother board (M/B) chip set 102, a main memory 103, a video card 104, a hard disk 105, a network interface 106, a floppy [symbol] disk drive 107, a keyboard 108, and an I/O port 109. The mother board (M/B) chip set 102 and a main memory 103 are connected to the CPU 101 through a system bus. The video card 104, the hard disk 105 and the network interface 106 are connected to the M/B chip set 102 through a high-speed bus such as a PCI bus. The floppy [symbol] disk drive 107, the keyboard 108 and the I/O port 109 are connected to the M/B chip set 102 through the high-speed bus, the bridge circuit 110 and a low-speed bus such as an ISA bus.

FIG. 1 illustrates only an example of a computer apparatus configuration through which an embodiment of the present invention is realized. Any system configuration other than that shown in FIG. 1 may be adopted if an embodiment of the present invention can be applied to it.

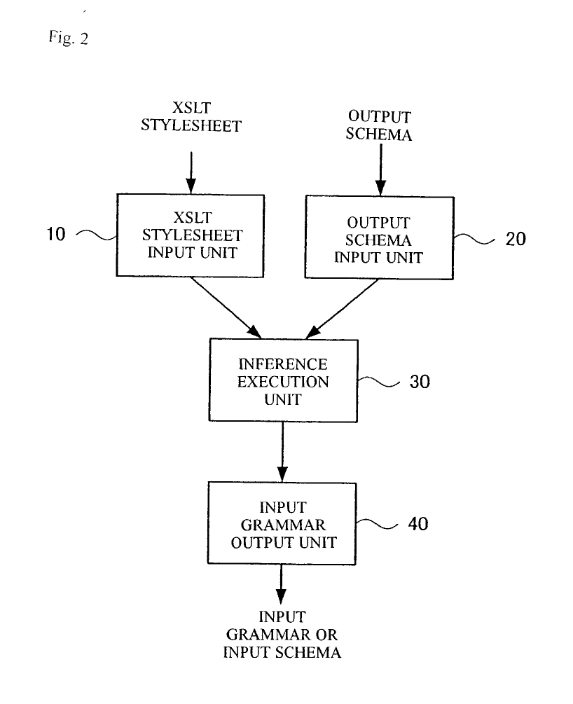

FIG. 2 is a diagram showing a configuration of the schema generation and verification system embodying the present invention and realized by the computer apparatus shown in FIG. 1. Referring to FIG. 2, the system of this embodiment has an XSLT stylesheet input unit 10 to which an XSLT stylesheet which is an object to be processed is input, an output schema input unit 20 to which an output schema which is an object to be processed is input, an inference execution unit 30 which generates, by applying inference rules, a production rule group constituting a document schema (input schema) to be generated, and an input grammar output unit 40 which outputs in various forms an input grammar having the production rule group produced by the inference execution unit 30.

The components of the schema generation and verification system shown in FIG. 2 are virtual software blocks realized by controlling the CPU 101 by a program loaded in the main memory 103 shown in FIG. 1. The program for realizing these functions by controlling the CPU 101 may be provided by being distributed in a state of being stored on a magnetic disk, an optical disc, a semiconductor memory or any other storage medium, or by being distributed over a network. In this embodiment, the program is input through the network interface 106, the floppy [symbol] disk drive 107 shown in FIG. 1, a CD-ROM drive (not shown), or the like, and is stored on the hard disk 105. The program stored on the hard disk 105 is read to the main memory 103 and is executed by the CPU 101 to realize the functions of the components shown in FIG. 2.

In the schema generation and verification system shown in FIG. 2, the XSLT stylesheet input unit 10 is supplied with a script of an XSLT stylesheet (hereinafter referred to as “XSLT script”) and converts the script into an XSLT expression.

An XSLT script stored on the hard disk drive 105 shown in FIG. 1 may be read out as an object to be processed by the XSLT stylesheet input unit 10. Also, an XSLT script may be input from an external unit through the network interface 106, or may be input through the keyboard 108 or any other input means. The converted XSLT expression is stored in a cache memory of CPU 101 or in the main memory 103 shown in FIG. 1.

It is advantageous that the XSLT expression is written be a tree structure easily understandable for the computer, which is expressed in the Backus Naur Form (BNF) notation or the like. An XSLT script itself may be considered an XSLT expression. An actual XSLT script, however, has redundancy, i.e., a plurality of descriptions for one same operation. In this embodiment, therefore, instructions are roughly grouped into seven basic XSLT expression constructs shown below by combining each group of instructions similar in function to each other. Details and terms (current node, child node sequence, literal result element) of XSLT statements shown below are described in the W3C recommendation: XSL Transformations (XSLT) Version 1.0 (W3C Recommendation Nov. 16, 1999) http://www.w3.org/TR/xslt.

(1) expression constructs e, e′ represent sequences of XSLT statement;

(2) element (s){e} corresponds to generation of a literal result element of XSLT or to an element statement;

(3) copy{e} corresponds directly to a copy statement of XSLT;

(4) if(s){e} corresponds directly to a case where a test is made by an if statement of XSLT with respect to an element name of a current node;

(5) foreach{e} corresponds directly to a case where a child sequence, i.e., ./*, is selected by a for-each statement of XSLT;

(6) mx.{e} is a component corresponding directly to a call-template statement and representing a recursive call; and

(7) f is an expression construct corresponding to an empty XSLT statement.

For example, an apply-templates statement frequently used in XSLT corresponds to an XSLT expression:

mx. {. . . {for-each{x}. . . }

Also, with respect to a value-of statement, an operation comprising selecting and outputting all nodes subordinate to its node corresponds to an XSLT expression:

mx. {copy{for-each{x}}}

Further, for matching of a template statement to a certain element name s, if(s){e} component can be used. In other various cases, an XSLT expression can imitate a XSLT script. Not all XSLT scripts can be expressed by using the above-described expression constructs. However, it can be said that almost all XSLT scripts include part or all of the above-described expression constructs.

The output schema input unit 20 is supplied with an output schema described in a schema language such as DTD or RELAX (REgular LAnguage description for XML), and converts the output schema into a suitable grammar (hereinafter referred to as “output grammar”). In this embodiment, the output schema input unit 20 converts an output schema into a binary tree grammar.

An output schema stored on the hard disk drive 105 shown FIG. 1 may be read out as an object to be processed by the output schema input unit 20. Also, an output schema may be input from an external unit through the network interface 106, or may be input through the keyboard 108 or any other input means. The converted output grammar is stored in the cache memory of CPU 101 or in the main memory 103 shown in FIG. 1.

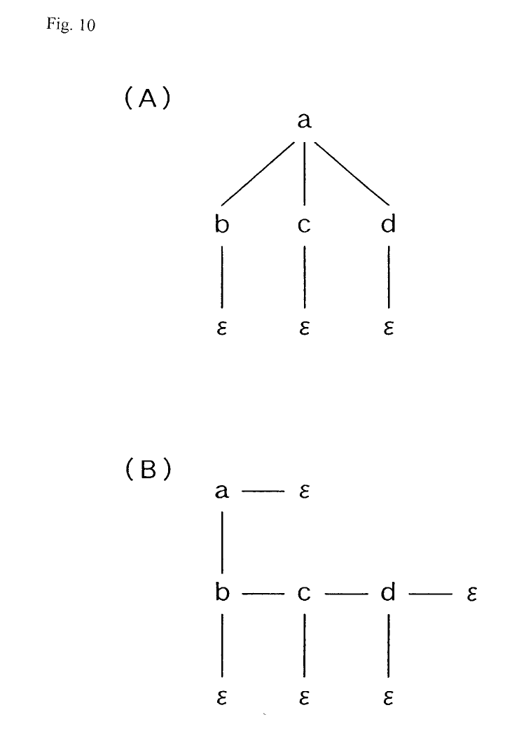

A description will now be made on a binary tree grammar. A tree shown in FIG. 10(A) and a binary tree shown in FIG. 10(B) are in unique correspondence with each other. Almost all document type definitions such as DTD have expression in a tree language class called a regular tree language, as represented by a tree such as shown in FIG. 10(A). This expression is in a range called a regular binary tree language in the tree shown in FIG. 10(B). A binary tree grammar forming this regular binary tree language is expressed by a set of non-terminal symbols, a production rule, a terminal symbol, and a start symbol.

Existing techniques may be used for conversion from a schema described in DTD or RELAX into a binary tree grammar.

The inference execution unit 30 performs an operation comprising repeatingly applying an inference rule (hereinafter referred to as “inference operation”) from the whole of XSLT expressions and an output schema to the end of the program. During this inference operation process, the inference execution unit 30 generates a grammar for a document schema to which an input document should conform. This grammar is hereinafter referred to as “input grammar”.

In the inference execution unit 30, it is necessary to prepare an inference rule group as correctly as possible with respect to the element generation instructions of an XSLT expression. A description will be made below on what rule group is said to be correct.

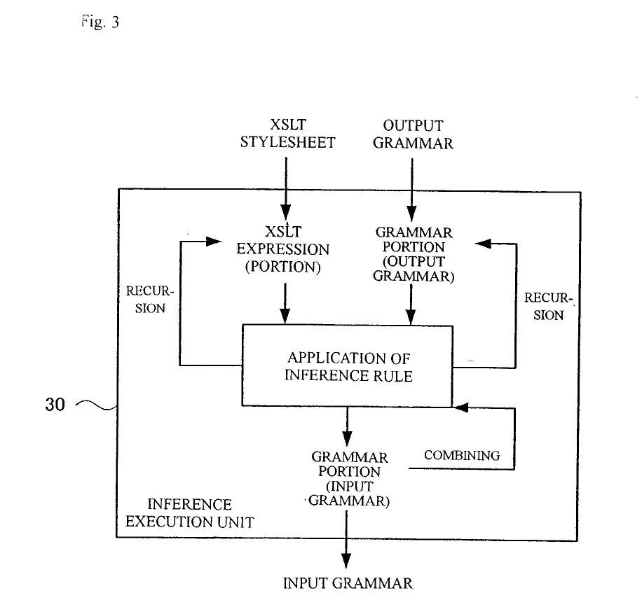

FIG. 3 is a diagram for explaining the inference operation of the inference execution unit 30. Referring to FIG. 3, in the inference operation, an XSLT expression (portion) and an output grammar portion to be checked among XSLT expressions and portions of an output grammar held in the cache memory of the CPU 101 or the main memory 103 shown in FIG. 1 are first read out, and inference thereon is separately executed to output a grammar portion of an input grammar. Grammar portions obtained in this manner are combined to generate an input grammar. If there is a partial expression, i.e., a portion parenthesized with { }, in the XSLT expression which is being checked in the inference operation, a recursive inference rule is applied to the partial expression. The operation for inference of a higher-order grammar portion is executed by using grammar portions of input grammars obtained from lower-order partial expressions. The generated input grammar may be of any form. However, it is preferred that it enables description of a schema in a regular tree language. The input grammar generated by the inference execution unit 30 is held in the cache memory of the CPU 101 or the main memory 103 shown in FIG. 1.

A grammar portion of a binary tree grammar is expressed by a set of two non-terminal symbols (q, q′). This represents a set of documents produced in such a case that with respect to a start symbol q rewriting expressed by q′ ® e is permitted only if the symbol appearing at the right end of the document which is being produced is the non-terminal symbol q′. It is thereby ensured that only a document formed by placing a document produced from a grammar portion (q′, q″) after the document produced from the grammar portion (q, q′) is obtained as a document produced from a grammar portion (q, q″).

Even in a case where no binary tree grammar is used, it is necessary to consider the data structure corresponding to grammar portions. For example, if DTD is as expressed by

<!ELEMENT doc (a*,b*)>

a content model for the doc-element is expressed as a concatenation of two grammar portions as shown below. That is, there are two concatenations:

(a)* and (a*,b*)

(a*,b*) and (b)*

The grammar portion of one a-element is a portion from which only a document in the form of <a>1/</a> is produced. The grammar portion of one element contained in the content model of the doc-element is (a|b). Concrete contents of inference rules and an inference operation procedure will be described below.

The input grammar output unit 40 reads out an input grammar generated by the inference execution unit 30 from the cache memory of the CPU 101 or the main memory 103 shown in FIG. 1, converts it into a form such that it can be actually used (i.e., a document schema based on a schema language such as DTD), and outputs the converted input grammar. The input grammar output unit 40 not only operates as a conversion means for converting an input grammar into a document schema but also outputs the generated input grammar without changing it, for example, in a case where the generated input grammar is compared with another grammar to determine the inclusion relationship therebetween.

In the embodiment of the present invention arranged as described above, the following are ensured. In a case where schema generation from inputs which are a predetermined XSLT stylesheet and a predetermined output schema is performed, a document schema thereby generated is sound as an input schema. That is, all XML documents (input documents) which conform to this document schema are unfailingly converted, by the XSLT stylesheet which has been processed, into XML documents (output documents) which conform to the output schema which has been processed.

That is, the present invention makes it possible to mechanically determine whether an XSLT stylesheet is correct or incorrect in the sense that if an XML document which conforms to an expected input schema is given, an XML document which conforms to an expected output schema is output. Therefore, if the present invention is used, it is not necessary for a programmer to perform a XML document conversion test or the like by him/herself for the purpose of detecting an error in an XSLT stylesheet. The burden on the programmer is thereby reduced.

On the other hand, the generated document schema is complete as an input schema. That is, if a certain XML document (input document) is converted, by the XSLT stylesheet which has been processed, into an XML document (output document) which conforms to the output schema which has been processed, the input document surely conforms to the document schema generated in accordance with this embodiment of the present invention.

It is important that the generated document schema is sound and complete. Correctness of the above-described inference rule group is none other than a condition for ensuring that the generated document schema is sound or complete or both sound and complete. Both soundness and completeness of the document schema can be ensured by using a regular tree language as each of the output and input schemas.

A concrete example of a procedure for inference operations performed by the inference execution unit 30 and the contents of inference rules will now be described. As described above, the schema generation and verification system in accordance with this embodiment of the present invention is supplied with an XSLT stylesheet and an output schema and generates an input schema production rule group. That is, the schema generation and verification system performs schema inference in the reverse direction. Conversely, the schema generation and verification system may be supplied with an XSLT stylesheet and an input schema and may perform schema inference in the forward direction for generating an output schema production rule group. In this embodiment, schema inference in the reverse direction is adopted since inference in the reverse direction is more practically useful than inference in the forward direction.

The inference execution unit 30 is supplied with an XSLT expression to be checked and a grammar portion to be checked in an output grammar and performs inference to output a grammar portion of an input grammar, as shown in FIG. 3. It is assumed that the grammar portion of the input grammar to be output is necessarily a one-element grammar portion, while the output portion of the output grammar supplied is such as to represent an arrangement of a plurality of elements or a zero element.

It is not necessary to perform inference two times with respect to the same combination of a grammar portion in inputting and XSLT expression. When inference with respect to each combination is completed, the results of inference of the combination of a grammar portion and XSLT expression are stored, for example, by being registered in a table to be thereafter used. If, in the course of inference with respect to the combination of a grammar portion and XSLT expression, an inference with respect to itself is demanded, a result UNDEF (undefined) is immediately returned.

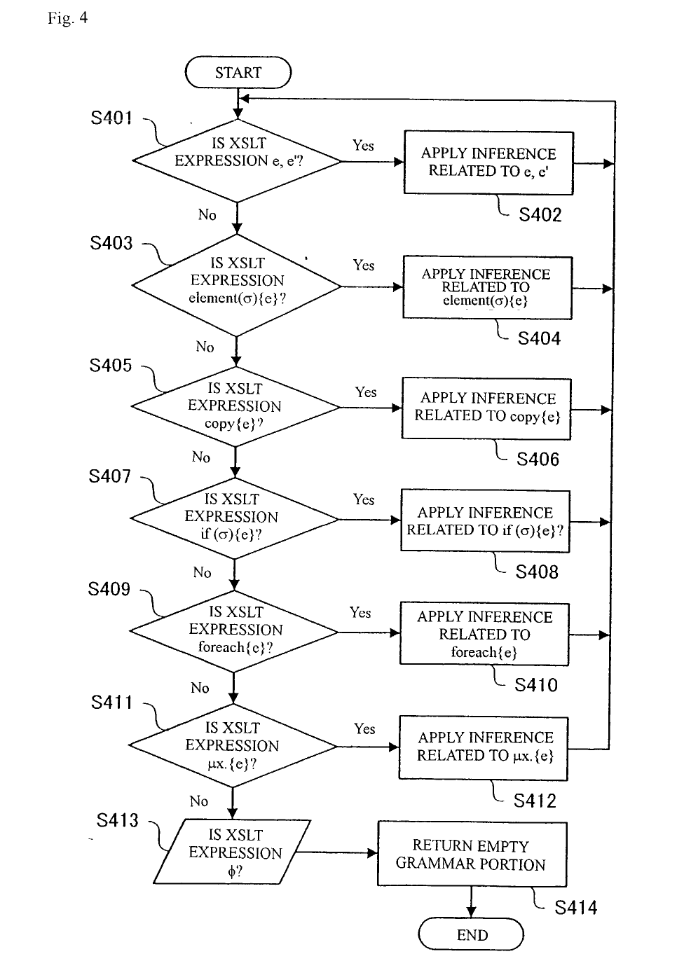

FIG. 4 is a flowchart for explaining the procedure of inference performed by the inference execution unit 30. Referring to FIG. 4, the inference execution unit 30 supplied with an XSLT expression and a grammar portion of an output grammar to be processed examines the XSLT expression to determine one of the above-described seven basic kinds of component to which the XSLT expression corresponds, and applies an inference rule according to the basic component (steps 401 to 414). In the process shown in FIG. 4, the steps for determination of the kind of XSLT expression as one of the basic kinds of component are performed in the order of the basic components (1) to (7) described above for convenience sake. However, the determination steps may be performed in any other order since any process suffices in which the corresponding basic component can be identified and the corresponding inference can be performed.

First, in the process shown in FIG. 4, if the XSLT expression to be processed is e, e′ shown as the basic component (1), the inference execution unit 30 applies an inference rule described below (steps 401, 402). All grammar portion combinations are obtained in which a grammar portion (B) of the output grammar to be processed can be expressed by a concatenation of predetermined two grammar portions (B1) and (B2). In a case where the output grammar is a binary tree grammar, if the grammar portion (B) is (q, q″), combinations of grammar portions (q, q′) and (q′, q″) are obtained with respect to all non-terminal symbols q′. With respect to grammar portions (B1) and (B2) in each combination,

Result (C1) of application of inference operation to XSLT expression e and grammar portion (B1), and

Result (C2) of application of inference operation to XSLT expression e′ and grammar portion (B2)

are obtained. If each of (C1) and (C2) is not UNDEF, a common portion (C3) is obtained with respect to (C1) and (C2), which includes only documents each producible from each of the two grammar portions.

Next, a sum (C) is obtained which includes all documents each produced from either of the results (C3) from all division of the grammar portion (B). This sum (C) corresponds to a grammar portion of an input grammar obtained as an inference result. Consequently, the inference execution unit 30 outputs the grammar portion (C).

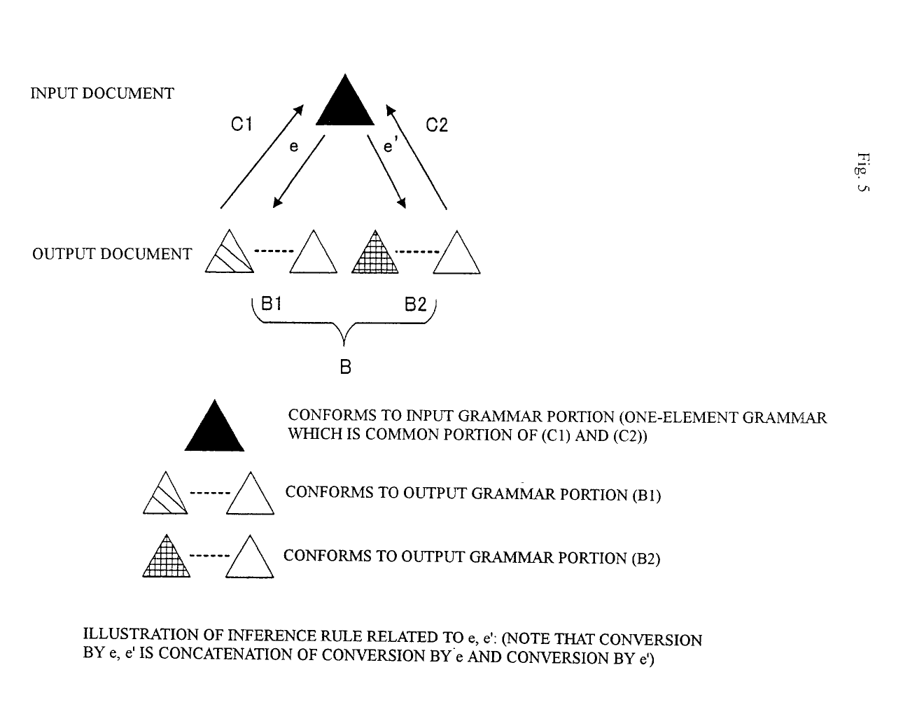

FIG. 5 illustrates the above-described inference rule. A common portion of a plurality of grammars or grammar portions is a set of documents each of which can be produced by each of the grammars or grammar portions. The sum of a plurality of grammars or grammar portions is a set of documents each of which can be produced by one of the grammars or grammar portions. A method for simply obtaining a common portion or a sum in an ordinary binary tree grammar is well known. In the present invention, however, there is a possibility of the internal structure of grammar portions being unknown when a common portion or a sum is obtained from the grammar portions, i.e., a possibility of recursive inference being required. As a technique for solving this problem, an algorithm for delayed computation of a common portion and a sum is known. For example, such an algorithm is described in detail in a document written by D. E. Muller and P. E. Schupp: Alternating automata on infinite trees, Theoretical Computer Science, 54,;267-276, 1987.

If the XSLT expression to be processed is element (s){e} shown as the basic component (2), the inference execution unit 30 applies an inference rule described below (steps 403, 404).

A grammar portion having one s-element and having a child in which a grammar portion (B1) appears is searched for in a grammar portion (B) of the output grammar to be processed. In a case where the output grammar is a binary tree grammar, the grammar portion (B1) is (q″, q′″) if q″ is such that q ® s (q″, q′) with respect to (q, q′). Symbol q′″ is a non-terminal symbol such that q′″ ® e in the binary tree grammar.

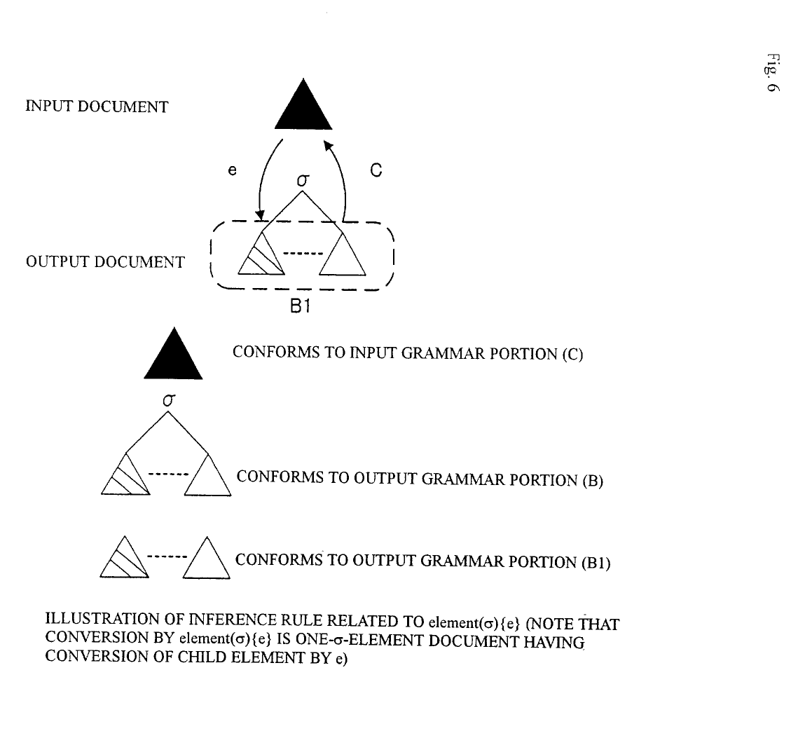

A result (C1) of application of inference operation to XSLT expression e and grammar portion (B1) is a grammar portion (C) of an input grammar obtained an inference result. However, if there are a plurality of non-terminal symbols q′″ of q′″ ® e, the sum of (C1) with respect to all q′″ is obtained as the inference result grammar portion (C). If (C1) is always UNDEF, (C) is also UNDEF. FIG. 6 illustrates the above-described inference rule.

If the XSLT expression to be processed is copy{e} shown as the basic component (3), the inference execution unit 30 applies an inference rule described below (steps 405, 406).

A grammar portion having one s-element with an arbitrary element name s and having a child in which a grammar portion (B1) appears is searched for in a grammar portion (B) of the output grammar to be processed. In a case where the output grammar is a binary tree grammar, the grammar portion (B1) is (q″, q′″) if q″ is such that q ® s (q″, q′) with respect to (q, q′). Symbol q′″ is a non-terminal symbol such that q′″ ® e in the binary tree grammar.

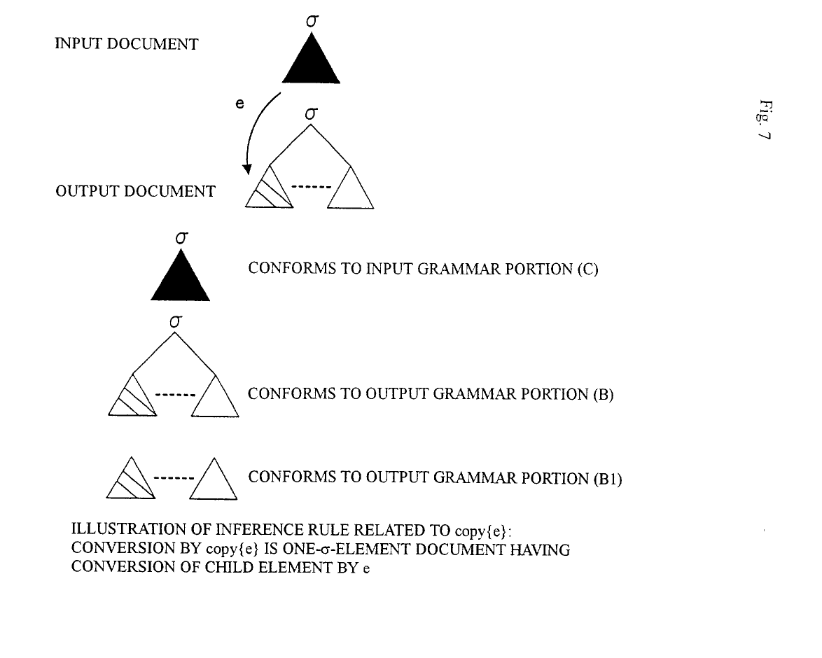

In a result (C1) of application of inference operation to XSLT expression e and grammar portion (B1), a grammar portion formed of one s-element is a grammar portion (C) of an input grammar obtained as an inference result. However, if there are a plurality of non-terminal symbols q′″ of q′″ ® e, the sum of one-s-element grammar portions (C1) with respect to all q′″ is obtained as the inference result grammar portion (C). If (C1) is always UNDEF, (C) is also UNDEF. FIG. 7 illustrates the above-described inference rule.

If the XSLT expression to be processed is if(s){e} shown as the basic component (4), the inference execution unit 30 applies an inference rule described below (steps 407, 408).

Result (C1) of application of inference operation to XSLT expression e and a grammar portion (B1), and

Result (C2) of application of inference operation to XSLT expression e′ and a grammar portion e representing an empty document

are obtained. A sum (C) of a grammar portion expressed as a sequence of one s-element in (C1), and (C2) is a grammar portion of an input grammar obtained as an inference result. If no such grammar portion exists, the result is UNDEF.

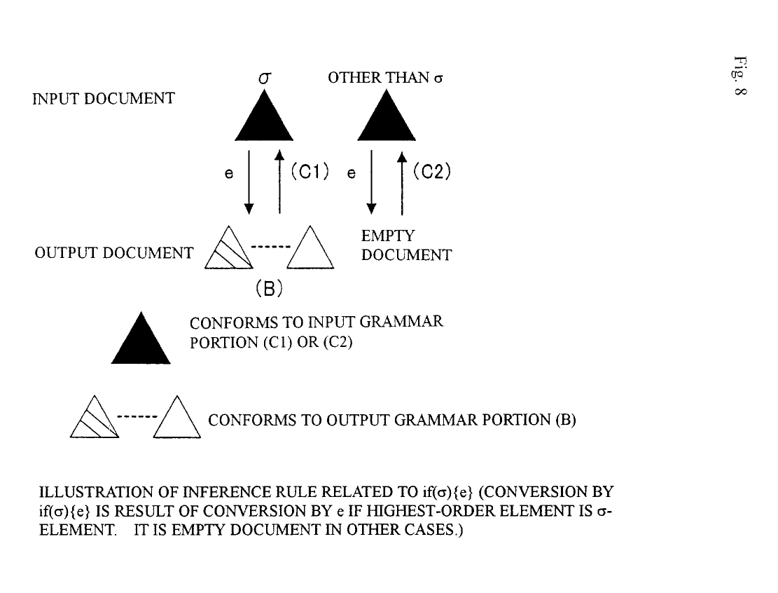

FIG. 8 illustrates the above-described inference rule.

If the XSLT expression to be processed is foreach{e} shown as the basic component (5), the inference execution unit 30 applies an inference rule in two procedures described below (steps 409, 410).

1: An input grammar production rule is added. A case of a binary tree grammar will first be discussed. It is assumed here that in a binary tree grammar a non-terminal symbol is given in the form of X^{q}_{q′,e}. In a binary tree grammar, the number of grammar portions in an output grammar is only the second power of the number of non-terminal symbols. Therefore all the grammar portions can be counted up. If one of the grammar portions (Bk) is (q′, q″),

Result (Ck) of application of inference operation to XSLT expression e and the grammar portion (Bk)

is obtained with respect to this grammar portion (Bk). (Ck) is assumed to be a grammar portion of an input grammar expressed as a sequence of one s-element with respect to some number of s, and having a child with a start symbol w. Then, with respect to arbitrary q, a production rule expressed by

X^{q}_{q′e}® s(w, X^{q}_{q″,e})

is given. It is not necessary to make this production rule with respect to arbitrary q. One production rule as expressed by X_{q′,e}® s(w, X_{q″,e}) may be used representative of others. Addition of this input grammar production rule may be repeated with respect to all portions (Bk), or may be repeated with respect to sub-portions (Bk) corresponding to a grammar portion (B) of the output grammar to be processed. Further, a rule expressed by

X^{q}_{q}® e

is also added.

The grammar portion (B) to be processed is assumed to be a grammar portion (q, q′). The grammar portion (B) can be disassembled into concatenations (B1), . . . , (Bn) of n sub-grammar portions. However, if a binary tree grammar is used, it is ensured with respect to k Î 1, . . . , n that, if a grammar portion (X^{q}_{q,e}, X^{q}_{q′,e}) of the input grammar, which is a child of (C), is disassembled into one-element grammar portions (C1), . . . , (Cn), and if inference operation is applied to (Ck) and XSLT expression e, then (Bk) results. If a rule can be made such as to ensure the same effect without using a binary tree grammar, such a rule may alternatively be used.

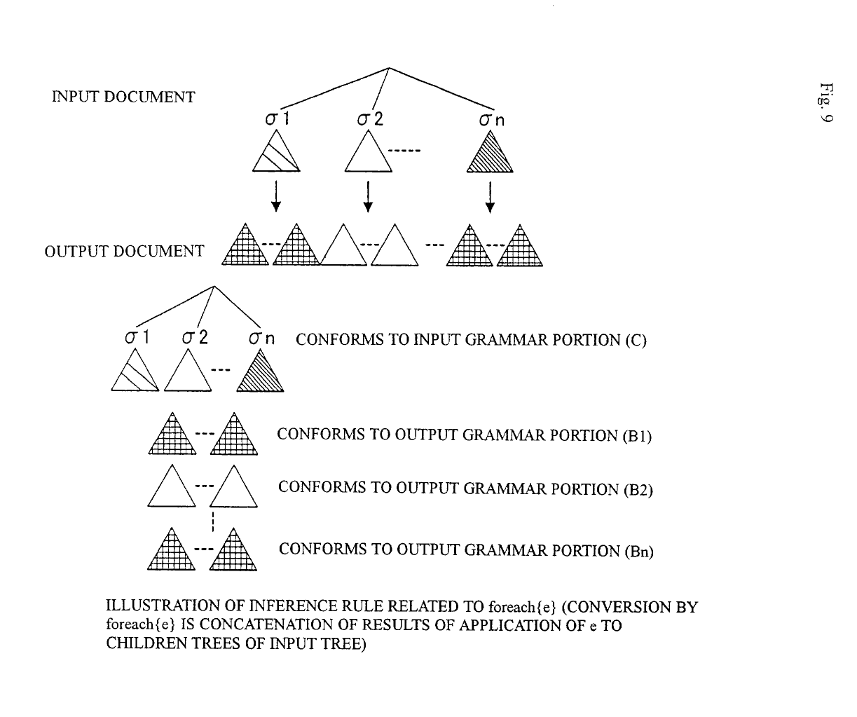

2: The grammar portion (C) returned as an inference rule result is a grammar portion of the input grammar such that its child has start symbol X^{q}_{q′,e} with respect to arbitrary s. FIG. 9 illustrates the above-described inference rules.

If the XSLT expression to be processed is mx.{e} shown as the basic component (6), the inference execution unit 30 applies an inference rule described below (steps 411, 412). An expression formed by substituting mx.{e} for x which appears freely in XSLT expression e, i.e., x not appearing in e′ in mx.{e′}, is represented by e″. A result (C) of application of inference operation to e″ and a grammar portion (B) is a grammar portion of an input grammar. If the XSLT expression to be processed is f shown as the basic component (7), the inference execution unit 30 applies an inference rule described below (steps 413, 414). If a grammar portion (B) includes e, a grammar portion (C) generating a one-s-element sequence having any child with respect to arbitrary s is obtained as a grammar portion of an input grammar. In other cases, the result is UNDEF. Inclusion of e in the grammar portion (B) is equivalent to a grammar portion in the form of (q, q) in a binary tree grammar.

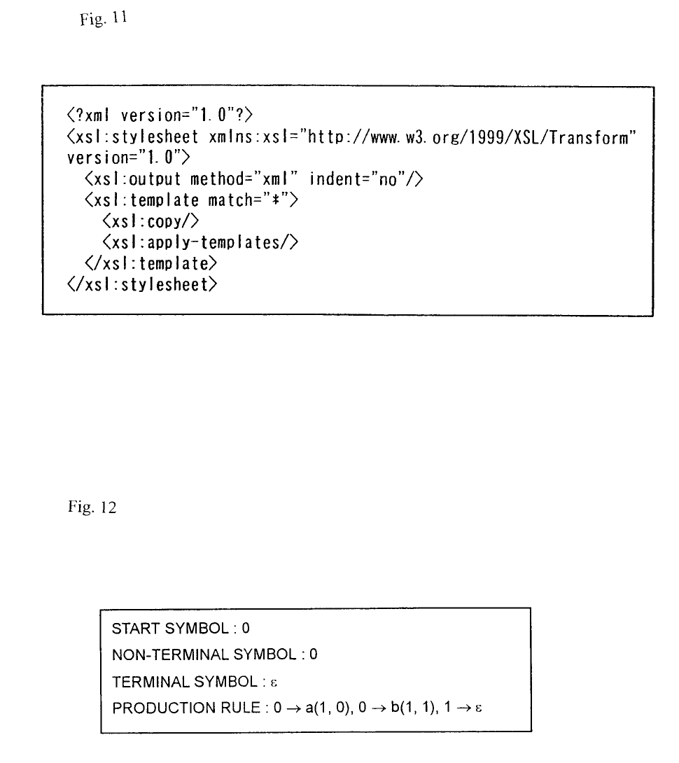

An example of generation of an input grammar in this embodiment will next be described. FIG. 11 is a diagram showing an XSLT script which is an object processing. FIG. 12 is a diagram showing an output grammar which is another object of processing.

The XSLT script shown in FIG. 11 converts an XML document:

```
<a>
      <a/>
      <b/>
</a>
```

into

<a/></a><b/>

The output grammar shown in FIG. 12 is a grammar with which

. XML document <b/> (= b(e,e))
. XML document <a/><b/> (= a(e, b(e,e)))
. XML document <a/><a/><b/> (= a(e, a(e, b(e,e))))
. XML document <a/><a/><a/><b/>

(= a(e, a(e, a(e, b(e,e)))))

are expressed.

The XSLT stylesheet input unit 10 is supplied with the XSLT script shown in FIG. 11 and converts this script into an XSLT expression. This XSLT expression is as shown below.

mx.{copy{f}, foreach{x}}

The converted XSLT expression is sent to the inference execution unit 30.

The output schema input unit 20 is supplied with the output schema and converts the output schema into an output grammar. However, since the output grammar shown in FIG. 12 is provided in this case, it is directly sent to the inference execution unit 30.

Next, the inference execution unit 30 executes inference of an input grammar on the basis of the input XSLT expression and output grammar.

(i) First, inference is initiated from XSLT expression mx.{copy{f}, foreach{x}} and a grammar portion (0, 1) representing the entire output schema. Since the expression to be processed is in the form of mx.{e}, the above-described inference rule related to mx.{e} is applied. At this time, all occurrences of x which appear freely in e are rewritten into mx.{e} to obtain:

copy, foreach{mx.{copy, foreach{x}}}

Subsequently, e! is substituted for mx.{copy, foreach{x}}

(ii) Inference operation is recursively applied to XSLT expressions copy{f}, foreach{e!} and the grammar portion (0, 1). The inference rule related to e, e′ is thereby applied with respect to grammar portions (0, 0) and (0,1), and (0, 1) and (1, 1) divided from the grammar portion (0, 1).

(iii) Inference with respect to the grammar portion (0, 0) in the grammar portion (0, 0) and (0, 1) is performed as described below. That is, inference operation is applied to XSLT expression copy{f} and the grammar portion (0, 0). Then, a one-element sequence in a document produced on the basis of (0, 0) and the production rule in the output grammar shown in FIG. 12 is as shown below:

XML document <a/>(=a(e,e))

That is, it is a grammar portion having one a-element and its child is a grammar portion (1, 1) representing an empty document.

Then, inference operation is recursively applied to XSLT expression f and the grammar portion (1, 1), thereby obtaining an input grammar which may have any element s and any child.

According to this result, the result obtained by applying inference operation to XSLT expression copy{f} and the grammar portion (0, 0) is an input grammar portion which must have an a-element, and which may have any child.

(iv) Inference with respect to the grammar portion (0, 1) in the grammar portion (0, 0) and (0, 1) is performed as described below. That is, inference operation is applied to XSLT expression foreach{e!} and the grammar portion (0, 1). For inference with respect to XSLT expression foreach{e!}, there is a need to perform computation of the grammar portion and computation in accordance with the production rules, as described above. At this time point, however, only computation of the grammar portion is performed. Computation in accordance with the production rules is performed afterward. By computation of the grammar portion, an input grammar portion is obtained such that its child has start symbol X01,e! with respect to arbitrary s-element.

(v) Inference with respect to the grammar portion (0, 1) in the grammar portion (0, 1) and (1, 1) is performed as described below. That is, inference operation is applied to XSLT expression copy{f} and the grammar portion (0, 1). Then, a one-element sequence in a document produced on the basis of (0, 1) and the production rule in the output grammar shown in FIG. 12 is as shown below.

XML document <b/>(=b(e,e))

That is, it is a grammar portion having one a-element and its child is a grammar portion (1, 1) representing an empty document.

Then, inference operation is recursively applied to XSLT expression f and the grammar portion (1, 1), thereby obtaining an input grammar which may have any element s and any child.

According to this result, the result obtained by applying inference operation to XSLT expression copy{f} and the grammar portion (0, 1) is an input grammar portion which must have b-element, and which may have any child.

(vi) Inference with respect to the grammar portion (0, 1) in the grammar portion (0, 1) and (1, 1) is performed as described below. That is, inference operation is applied to XSLT expression foreach{e!} and the grammar portion (1, 1). For inference with respect to XSLT expression foreach{e!}, there is a need to perform computation of the grammar portion and computation in accordance with the production rules, as described above. At this time point, however, only computation of the grammar portion is performed. Computation in accordance with the production rules is performed afterward. By computation of the grammar portion, an input grammar portion is obtained such that its child has start symbol X^{l}_{1,e′} with respect to arbitrary s-element.

(vii) After the above-described inference, the process returns to inference with respect to XSLT expressions copy{f}, foreach{e!} and the grammar portion (0, 1) in the inference step (ii). An input grammar portion thereby obtained is the sum of a common portion of the inference results of the inference steps (iii) and (iv) and a common portion of the inference results of the inference steps (v) and (vi).

According to the inference results of the inference steps (iii) and (iv), the common portion is a grammar portion of the input grammar which must have an a-element, and which has a child with a start symbol X⁰_{0,e!}.

On the other hand, according to the inference results of the inference steps (v) and (vi), the common portion is a grammar portion of the input grammar which must have a b-element, and which has a child with a start symbol X⁰_{1,e!}. The sum of these input portions is the input grammar portion to be obtained.

(viii) Further, with the result of the inference step (vii), the process returns to inference with respect to XSLT expression mx.{copy, foreachlx} and the grammar portion (0, 1) representing the entire output schema in the inference step (i). According to the inference result of the inference steps (vii), the input grammar portion to be obtained is the sum of a grammar portion of the input grammar which must have an a-element, and which has a child with start symbol X⁰_{1,e!}, and a grammar portion of the input grammar which must have a b-element, and which has a child with a start symbol X¹_{1,e′}. This is a grammar corresponding to a production rule and a start symbol X′ shown below.

Production rule:

X ® a (X⁰_{1,e′}, X′), X ® b (X¹_{1,e!}, X′), X ® e

Thus, the entire inference except computation in accordance with the production rules with respect to XSLT expression foreach{e!} is completed. In the above-described processing, the grammar portion of the input grammar is obtained with respect to XSLT expressions copy{f}, foreach{e!} and the grammar portion (0, 1). For computation in accordance with the production rules with respect to XSLT expression foreach{e!} and the grammar portion (0, 1), and for computation in accordance with the production rules with respect to XSLT expression foreach{e!} and the grammar portion (1, 1), inference equivalent to that described above must be executed with respect to each of the other grammar portions (0, 0), (1, 0), and (1, 1) of the output grammar. The results of this processing are as described in (ix) to (xi) below.

(ix) Inference operation is applied to XSLT expressions copy{f}, foreach{e!} and the grammar portion (0, 1). The inference rule related to e, e′ is thereby applied with respect to the grammar portions (0, 0) and (0, 0) divided from the grammar portion (0, 1).

The result of inference from the former is the same as the inference result computed in the inference step (iii). The result of inference from the latter is also a grammar portion which must have an a-element, and which has a child with a start symbol X⁰_{0,e′}.

Accordingly, the grammar portion which is a common portion of the two is an input grammar portion which must have an a-element, and which has a child with a start symbol X⁰_{1,e}.

(x) From the grammar portion (1, 0), the result is UNDEF since no corresponding production rule exists.

(xi) Inference operation is applied to XSLT expressions copy{f}, foreachfe!} and the grammar portion (1, 1). The inference rule related to e, e′ is thereby applied with respect to the grammar portions (1, 1) and (1, 1) divided from the grammar portion (0, 1).

In this case, the result from the former is UNDEF and, therefore, the result from the whole, i.e., common portions, is also UNDEF.

From the inference results from the above-described inference steps (i), and (xi) to (ix), the production rules excluding useless ones are as shown below.

X⁰_{0,e′} ® a(X⁰_{1,e!}, X⁰_{0,e′})

X⁰_{0,e′} ® a(X⁰_{1,e′}, X⁰_{0,e′})

X⁰_{0,e′} ® b (X^{l}_{1,e′}, X⁰_{1,e!})

X ® a(X⁰_{1,e!}, X′), X ® b(X¹_{1,e′}, X′)

X′ ® e, X⁰₀ ® e, X¹₁ ® e

The start symbol of the input grammar is X. The input grammar generated in the above-described manner is output by the input grammar output unit 40 after being converted into an input schema in a suitable schema language according to one's need.

If an XML document is converted by using the XSLT stylesheet provided as an object of processing so as to conform to the input grammar generated by inference executed by the inference execution unit 30 (or an input schema output from the input grammar output unit), an XML document which conforms to the output schema provided as an object of processing can be obtained. That is, consistency of the XSLT stylesheet, the input schema and the output schema can be ensured.

An example of an implementation of the schema generation and verification system in accordance with the above-described embodiment will next be described. As described, if this embodiment of the present invention is used, consistency of an XSLT stylesheet with an input schema and with an output schema can be confirmed. Therefore an embodiment of the present invention can be implemented in an XSLT stylesheet debugger.

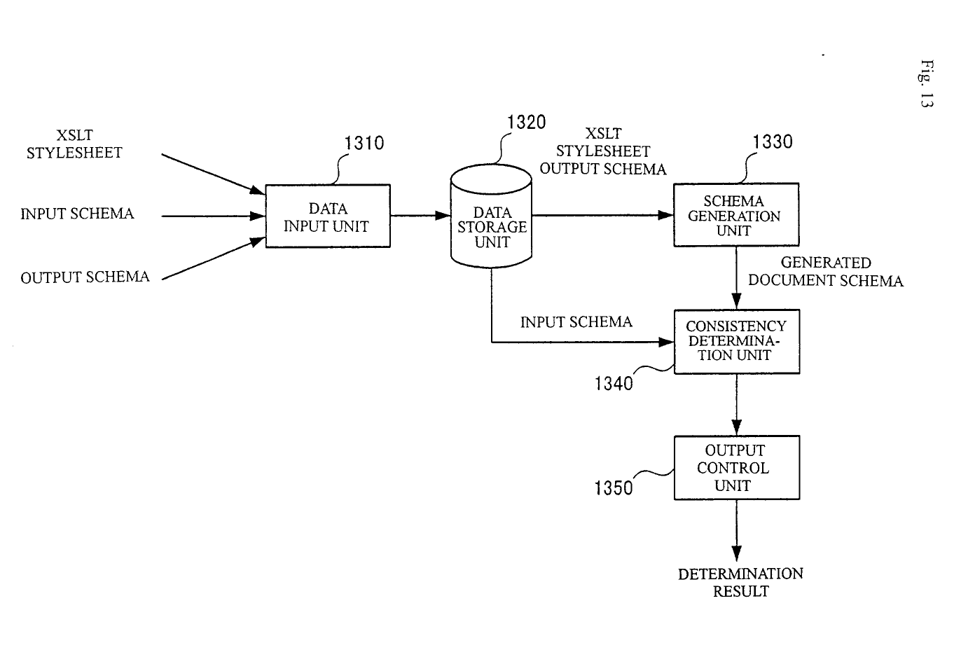

FIG. 13 is a diagram showing an example of a configuration of a debugger in which this embodiment of the present invention is implemented. Referring to FIG. 13, this debugger has a data input unit 1310 to which an XSLT stylesheet, an input schema and an output schema are input as objects of processing, a data storage unit 1320 in which the XSLT stylesheet, the input schema and the output schema input to the data input unit 1310 are stored, a schema generation unit 1330 corresponding to the schema generation and verification system in this embodiment of the present invention, a consistency determination unit 1340 which makes determination as to consistency of the XSLT stylesheet, the input schema and the output schema based on the document schema generated by the schema generation unit 1330, and an output control unit 1350 which outputs determination results from the consistency determination unit 1340.

The data input unit 1310, the consistency determination unit 1340 and the output control unit 1350 can be realized, for example, by the program-controlled CPU 101 shown in FIG. 1, as is the schema generation unit 1330 corresponding to this embodiment of the present invention. Also, the data storage unit 1320 is realized, for example, by the main memory 103 shown in FIG. 1.

The data input unit 1310 accepts a debug start instruction, for example, through an operating screen for accepting instructions from a user, which is displayed on a display device. In response to this instruction, the data input unit 1310 inputs an XSLT stylesheet script (XSLT script), an input schema and an output schema, supplied as objects to be processed, and stores the script and schemas in the data storage unit 1320.

The XSLT script, the input schema and the output schema, supplied as objects to be processed, can be identified on the above-described operating screen. Alternatively, an XSLT script, an input schema and an output schema stored on the hard disk 105 shown in FIG. 1 may be read out as objects to be processed. Also, an XSLT script, an input schema and an output schema may be input from an external unit through the network interface 106 or may be input through input means such as the keyboard 108, etc.

The schema generation unit 1330 corresponds to the schema generation and verification system in this embodiment of the present invention, as mentioned above. The schema generation unit 1330 reads out the XSLT script and the output schema from the data storage unit 1320, performs inference processing, and generates a document schema as an inference result. This document schema is converted into a state of being described in the same schema language as the input schema stored in the data storage unit 1320. This document schema is then sent to the consistency determination unit 1340.

The consistency determination unit 1340 receives the generated document schema from the schema generation unit 1330, reads out the input schema from the data storage unit 1320, and compares these schemas. If the document schema and the input schema are equal to each other or the input schema is included in the document schema, the consistency determination unit 1340 determines that the XSLT stylesheet, the input schema and the output schema have consistency. In other cases, it determines that the stylesheet and the schemas do not have consistency.

The output control unit 1350 outputs a comment on the result of determination made by the consistency determination unit 1340 through display on the display device or by means of speech. This output may be simple information on inconsistency of the XSLT style sheet, the input schema and the output schema. Alternatively, messages or the like selected as desired according to the setting of the object to be debugged may be output.

For example, if the input schema and the output schema to be used are predetermined, and if there is a need to check the correctness of the prepared XSLT stylesheet, consistency is determined by the debugger of this embodiment. In the case of consistency, a message saying that the XSLT stylesheet is correct is output. In the case of inconsistency, a message saying that the XSLT stylesheet is incorrect is output. If consistency is confirmed by collation of the input document with the input schema in the case where a conversion of an XML document is made by using the XSLT stylesheet determined as correct, it is ensured that the converted XML document surely conforms to the output schema.

Also, if the XSLT stylesheet and one of the input and output schemas to be used are predetermined, and if there is a need to check the correctness of the other of the input and output schemas, consistency is determined by the debugger of this embodiment. In the case of consistency, a message saying that the document schema is correct is output. In the case of inconsistency, a message saying that the document schema is incorrect is output.

In particular, in a case where there is a need to check the correctness of the input schema, if consistency is determined, the document schema generated by the schema generation unit 1330 may be output as an input schema model since the document schema is sound and complete as an input schema. In this manner, a user is enabled to compare the output document schema and the input schema to identify a content to be corrected.

This embodiment of the present invention may also be implemented, for example, in a system for verifying an input XML document which is input to a predetermined XSLT stylesheet. In this case, inference is performed as an initial operation on the basis of the XSLT stylesheet used and an output schema to which the XML document after conversion should conform, thereby producing an input schema to which the XML document input to the XSLT stylesheet should conform. Then, at a stage before the XML document is input to the XSLT stylesheet, the verification system of this embodiment compares the input schema produced in advance and the document schema of the XML document to check the document schema. In this case, if the document schema of the XML document is equal to or included in the input schema, the XML document is directly input to the XSLT stylesheet to be converted. In other cases, an error output may be issued to notify a user of incorrectness of the input document.

Another example implementation, is in which the schema generation and verification system of this embodiment is directly implemented to produce a desired input schema while an XSLT stylesheet to be used and an output schema are determined. This arrangement ensures that in a case where a maker of an XSLT stylesheet made the XSLT stylesheet by assuming a certain range of variations of an input schema without fixing the input schema, the necessary input schema can be automatically obtained.

While in this embodiment a document schema production rule is generated by using inference in the reverse direction, it is possible to construct a system in which a document schema production rule is generated by preparing a suitable inference rule and by performing inference in the forward direction. In such a case, the schema generation and verification system generates an output schema from an XSLT stylesheet and an input schema. In an example of implementation in this mode, a debugger may be arranged to output an output schema model or an output schema generation system may be implemented.

In the above-described embodiment, a binary tree grammar is used for expression of a rule for generating an output schema. However, this kind of grammar is used only for the purpose of improving the efficiency of computation for inference, and any other kind of grammar may be used to express an output schema production rule.

According to the present invention, as described above, it is possible to ensure that an XSLT stylesheet used for desired conversion processing conforms to an input schema and to an output schema. Therefore it is also ensured that the XSLT stylesheet can operate correctly, thereby reducing a working load corresponding to a test of the XSLT stylesheet for example. Further, according to the present invention, since consistency of an XSLT stylesheet with an input schema and an output schema is ensured, it is possible to ascertain the structural range of an XML document which can be converted into an XML document having a desired output schema in a case where no input schema exists.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein, and/or a method carrying out the functions herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements, apparatuses and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A schema generation apparatus comprising:
an XSLT stylesheet input unit for inputting an XSL Transformations (XSLT) stylesheet;
a schema input unit for inputting a document schema to which predetermined Extensible Markup Language (XML) data should conform; and
an inference execution unit for generating a production rule for expressing another document schema on the basis of the XSLT stylesheet input by said XSLT stylesheet input unit and the document schema input by said schema input unit, the production rule being derived by using a predetermined inference rule.

2. The schema generation apparatus according to claim 1, wherein said schema input unit substitutes a predetermined set of production rules for the document schema,
and said inference execution unit generates the production rule for expressing said another document schema on the basis of the predetermined set of production rules.

3. The schema generation apparatus according to claim 1, wherein said inference execution unit generates the production rule expressed in a regular tree language.

4. The schema generation apparatus according to claim 1, further comprising a conversion unit for converting the production rule generated by said inference execution unit into a concrete document schema in a predetermined schema language.

5. A schema generation apparatus, comprising:
an XSLT stylesheet input unit for inputting an XSL Transformations (XSLT) stylesheet;
a schema input unit for inputting a document schema to which predetermined Extensible Markup Language (XML) data generated as a result of conversion by the XSLT stylesheet should conform; and
a schema generation unit for generating a document schema to which XML data input to the XSLT stylesheet should conform on the basis of the XSLT stylesheet input by said XSLT stylesheet input unit and the document schema input by said schema input unit.

6. The schema generation apparatus according to claim 5, wherein said schema input unit substitutes a predetermined set of production rules for the document schema,
and said schema generation unit generates a production rule for expressing the document schema to which XML data input to the XSLT stylesheet should conform on the basis of the set of production rules and element generation instructions contained in the XSLT stylesheet.

7. A data processor, comprising:
an input unit for inputting an XSL Transformations (XSLT) stylesheet, an input schema which is a document schema to which Extensible Markup Language (XML) data before conversion by the XSLT stylesheet should conform, and an output schema which is a document schema to which the XML data after conversion by the XSLT stylesheet should conform;
a storage unit for storing the XSLT stylesheet, the input schema, and the output schema input by said input unit;
a schema generation unit for generating a predetermined document schema on the basis of one of the input schema and the output schema read out from said storage unit and the XSLT stylesheet read out from said storage unit; and
a determination unit for determining consistency of the XSLT stylesheet with the input schema and the output schema by comparing the document schema generated by said schema generation unit with the other of the input schema and the output schema read out from said storage unit.

8. The data processor according to claim 7, wherein said schema generation unit generates the predetermined document schema by inference in the reverse direction on the basis of the output schema and the XSLT stylesheet, and said determination unit compares the predetermined document schema with the input schema.

9. The data processor according to claim 7, wherein said determination unit determines that the XSLT stylesheet, the input schema and the output schema have consistency if the document schema is equal to the input schema with which it is compared, or if the document schema is included by the input schema.

10. A data processor, comprising:
an input unit for inputting an XSL Transformations (XSLT) stylesheet, an input schema which is a document schema to which Extensible Markup Language (XML) data before conversion by the XSLT stylesheet should conform, and an output schema which is a document schema to which the XML data after conversion by the XSLT stylesheet should conform;
a storage unit for storing the XSLT stylesheet, the input schema, and the output schema input by said input unit; and
a determination unit for reading out the XSLT stylesheet, the input schema, and the output schema from said storage unit, and for making a determination as to whether XML data obtained by converting the XML data conforming to the input schema by the XSLT stylesheet conforms to the output schema.

11. A data processing method using a computer, comprising the steps of:
storing, in an element generation instruction storage unit, element generation instructions contained in an XSL Transformations (XSLT) stylesheet;
storing, in a production rule storage unit, a production rule for expressing a document schema to which predetermined Extensible Markup Language (XML) data should conform; and
reading out the element generation instructions from the element generation instruction storage unit, reading out the production rule from the production rule storage unit, and generating a production rule for expressing another document schema on the basis of the element generation instructions and the production rule read out, the production rule being derived by using a predetermined inference rule.

12. The data processing method according to claim 11, wherein said step of generating the production rule includes a step of generating, by performing inference in the reverse direction, the production rule for the document schema to which the XML data input to the XSLT stylesheet should conform on the basis of the element generation instructions and the production rule for the document schema to which Extensible Markup Language (XML) data generated as a result of conversion by the XSLT stylesheet should conform.

13. The data processing method according to claim 11, wherein said step of generating the production rule includes a step of generating the production rule expressed in a regular tree language.

14. The data processing method according to claim 11, further comprising a step of determining correctness of the predetermined XML data or the XSLT stylesheet by comparing the document schema expressed by the production rule generated in said step of generating the production rule with the document schema relating to the predetermined XML data.

15. A program for controlling a computer to perform data processing, said program being making the computer to execute:
processing for storing, in an element generation instruction storage unit, element generation instructions contained in an XSL Transactions (XSLT) stylesheet;
processing for storing, in a production rule storage unit, a production rule for expressing a document schema to which predetermined Extensible Markup Language (XML) data should conform; and
processing for reading out the element generation instructions from the element generation instruction storage unit, reading out the production rule from the production rule storage unit, and generating a production rule for expressing another document schema on the basis of the element generation instructions and the production rule read out, the production rule being derived by using a predetermined inference rule.

16. A program for controlling a computer to perform data processing, said program being making the computer to execute:
processing for inputting and storing in a data storage unit an XSL Transformations (XSLT) stylesheet, an input schema which is a document schema to which Extensible Markup Language (XML) data before conversion by the XSLT stylesheet should conform, and an output schema which is a document schema to which the XML data after conversion by the XSLT stylesheet should conform;
processing for reading out one of the input schema and the output schema, and the XSLT stylesheet from the data storage unit, and for generating a predetermined document schema on the basis of the input schema or the output schema and the XSLT stylesheet; and
processing for determining consistency of the XSLT stylesheet with the input schema and the output schema by reading out one of the input schema and the output schema from the data storage unit, and by comparing the generated document schema with the input schema or the output schema.

17. A schema generation method comprising steps to carry out the functions of claim 1.

18. A schema generation method, comprising steps to carry out the functions of claim 5.

19. A data processing method, comprising steps to carry out the functions of claim 7.

20. An article of manufacture comprising a computer usable medium having computer readable program code means embodied therein for causing schema generation, the computer readable program code means in said article of manufacture comprising computer readable program code means for causing a computer to effect the steps of claim 17.

21. A program storage device readable by machine, tangibly embodying a program of instructions executable by the machine to perform method steps for schema generation, said method steps comprising the steps of claim 17.

22. A computer program product comprising a computer usable medium having computer readable program code means embodied therein for causing schema generation, the computer readable program code means in said computer program product comprising computer readable program code means for causing a computer to effect the functions of claim 1.
